(19) United States
(12) Patent Application Publication
(10) Pub. No.: US 2015/0197361 A1
(43) Pub. Date: Jul. 16, 2015

(54) VERTICAL CUTTER FOR WRAPPING MATERIAL

(71) Applicant: Hsiu-Man YU CHEN, Taichung (TW)

(72) Inventor: Hsiu-Man YU CHEN, Taichung (TW)

(21) Appl. No.: 14/668,136

(22) Filed: Mar. 25, 2015

Related U.S. Application Data
(63) Continuation-in-part of application No. 13/803,597, filed on Mar. 14, 2013.

(51) Int. Cl. B65B 61/06; B26F 3/02

(52) U.S. Cl. CPC B65B 61/06; B26F 3/02

(57) ABSTRACT

A cutter for wrapping material comprises a movable base having a positioning frame, a plurality of flat wings formed on the positioning frame, a first castor set having a plurality of one direction castors and a plurality of steerable castors formed on the flat wings, a second castor set having a plurality of castors, a bearing provided at the center of the positioning frame, and a turntable having a pivot hole positioned on the second castor set. The cutter also includes a load unit which comprises a shaft and a cutting unit which comprises a sliding rod installed in a frame forming into a lengthy hole and a blade base movably mounted on said sliding rod. With the load unit and the cutting unit vertically fixed on the movable base, the size of the cutter can be minimized and also convenient for a user to move the cutter.

The current application is a continuation-in-part of Ser. No. 13/803,597 filed on Mar. 14, 2013.

### BACKGROUND OF THE INVENTION

1. Field of the Invention

The present invention relates to a cutter and particularly relates to a vertical cutter for wrapping material.

2. Brief Description of the Prior Art

The conventional wrapping material such as bubble sheet or transparent plastic packing sheet is usually stored as a roll. User will need a cutter to cut the wrapping materials in a length suitable for a package. As shown in FIG. 1, a conventional cutter for wrapping material which was invented by the present inventor, includes a base 1, a shaft 2 pivotally fixed and aligned with the base 1, a cutter unit 3 substantially in the shape of frame being fixed on the base 1, and a blade 4 movably mounting on the frame of the cutter unit 3. A roll of wrapping material 5 will be loaded onto the shaft 2 and can be rotated on the same. When a package needs to be wrapped with the wrapping material 5, a portion of the wrapping material 6 will be pulled and pass through a slit on the frame of the cutter unit 3. Then the blade 4 is manually activated to move and cut off the packaging wrap 6 needed for a package.

It is apparently to see this conventional cutter can use used to obtain a wrapping material in a desired dimension very easily. However, since the base 1 and the cutter unit 3 are not collapsible, it is very difficult to move the cutter to a different location for packing operation. Moreover, with the shaft 2 and the cutting unit 3 fixed to the base 1, the entire cutter has a very bulky dimension and very inconvenient to be used in a work place.

### SUMMARY OF THE INVENTION

The principle advantage and object of the present invention is to provide a cutter for wrapping material which can be used to quickly cut off a portion of wrapping material to be used for a package.

Another object of the present invention is to provide a cutter for wrapping material which has the cutter unit structured vertically making the cutter to be easier for operation.

Still another object of the present invention is to provide a cutter for wrapping material which being equipped with rollers beneath the base for the entire cutter to be moved from one location to another for a desired packing operation.

A principal feature of the cutter for wrapping material according to the present invention is the wrapping material roll loading unit for the roll to be vertically loaded on the cutter with balance.

Accordingly a cutter for wrapping material according to the present invention comprises a movable base having a positioning frame which being in a shape with a first axis and a second axis perpendicular to said first axis, a plurality of flat wings formed at one end portion of said first axis of said positioning frame, a first castor set having a plurality of one direction castors and a plurality of steerable castors formed on said flat wings of said positioning frame, a second castor set having a plurality of castors on a circumference of said positioning frame, a bearing being provided at the center of said positioning frame, and a turntable having a pivot hole positioned on top of said castors of said second castor set;

a load unit comprises a shaft vertically passing through said pivot hole of said turntable and fixed on said bearing of said positioning frame, at least a fixing sleeve and a fastener fitted on said shaft; and

a cutting unit comprises a frame vertically fixed on said positioning frame, a sliding rod installed in said frame being parallel with said shaft of said load unit forming into a lengthy hole near said sliding rod, a blade base movably mounted on said sliding rod, a blade fixed on said blade base and positioning in said lengthy hole.

### BRIEF DESCRIPTION OF DRAWINGS

Those and other advantages, objectives and features can be apparent from the below detailed description of the preferred embodiment with reference to the accompanying drawings wherein:

FIG. 1 is a perspective view of a conventional cutter for wrapping material;

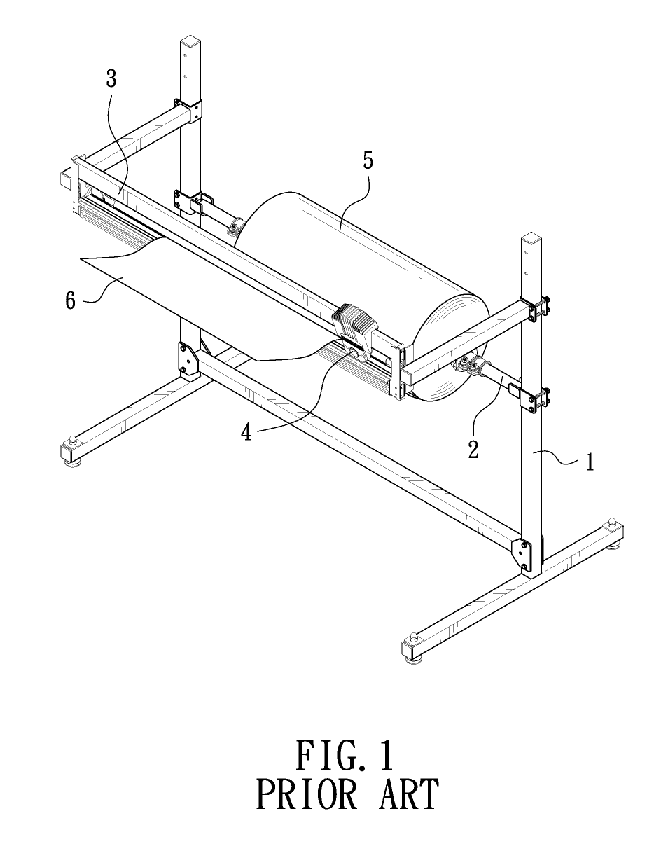

FIG. 2 is a perspective view of a preferred embodiment of a cutter for wrapping material according to the present invention;

FIG. 3 is an exploded view of the preferred embodiment of a cutter for wrapping material according to the present invention;

FIG. 4 is a cross-sectional view of the preferred embodiment of a cutter for wrapping material according to the present invention along line “4-4” in FIG. 2;

FIG. 5 is a bottom view of the preferred embodiment of a cutter for wrapping material according to the present invention;

FIG. 6 is a side elevation of the preferred embodiment of a cutter for wrapping material according to the present invention;

FIG. 7 is a cross-sectional view of the preferred embodiment of a cutter for wrapping material according to the present invention along line “7-7” in FIG. 2; and

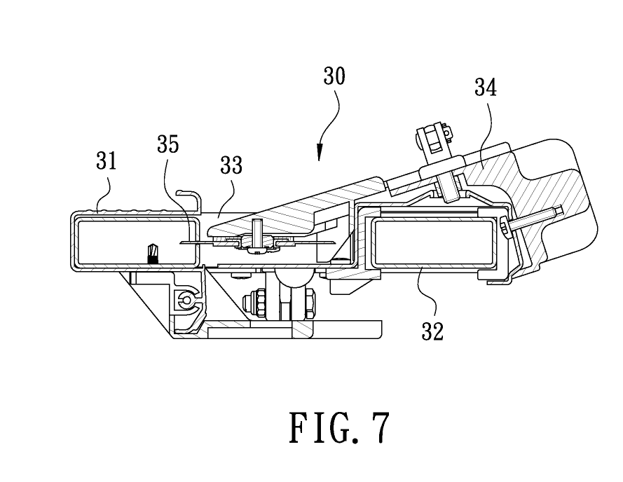

FIG. 8 is a perspective view of the preferred embodiment of the cutter for wrapping material according to the present invention showing it is operated.

### DETAILED DESCRIPTION OF THE PREFERRED EMBODIMENT

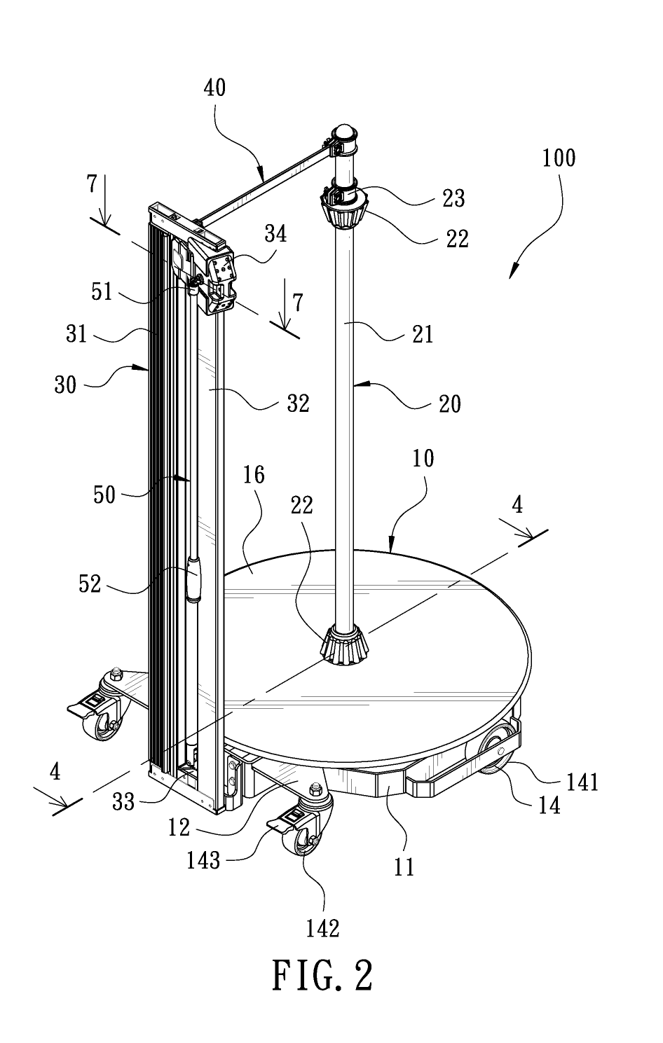

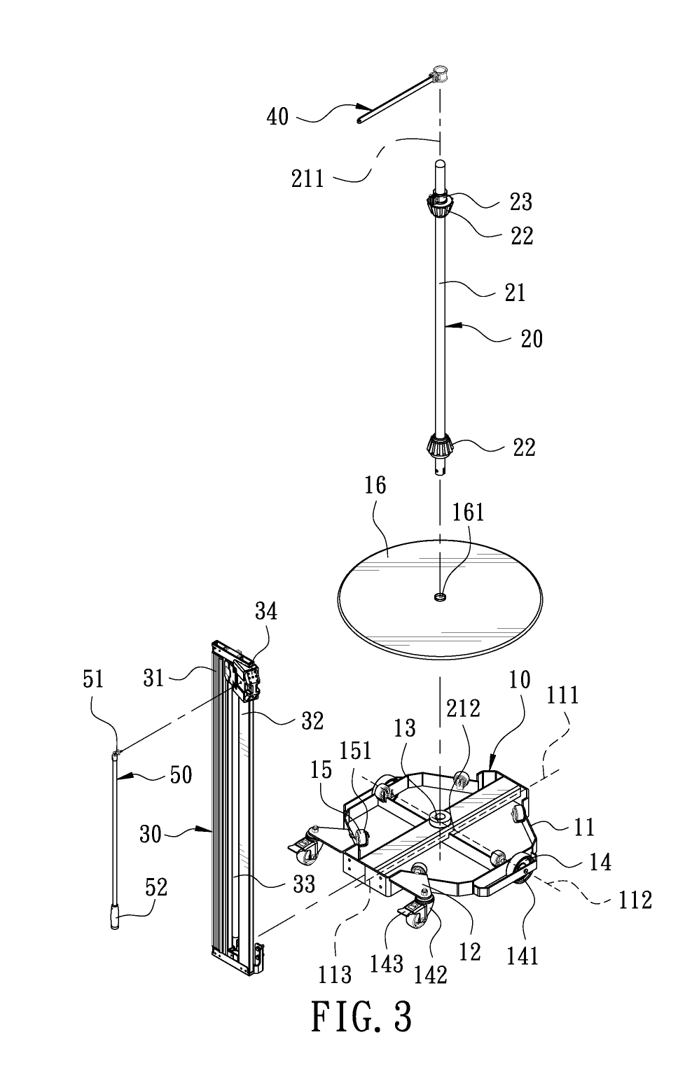

Referring to FIGS. 2 and 3, a preferred embodiment of a cutter for wrapping material 100 according to the present invention comprises a movable base 10, a load unit 20, a cutting unit 30, at least a bolster rod 40 and a blade lever 50.

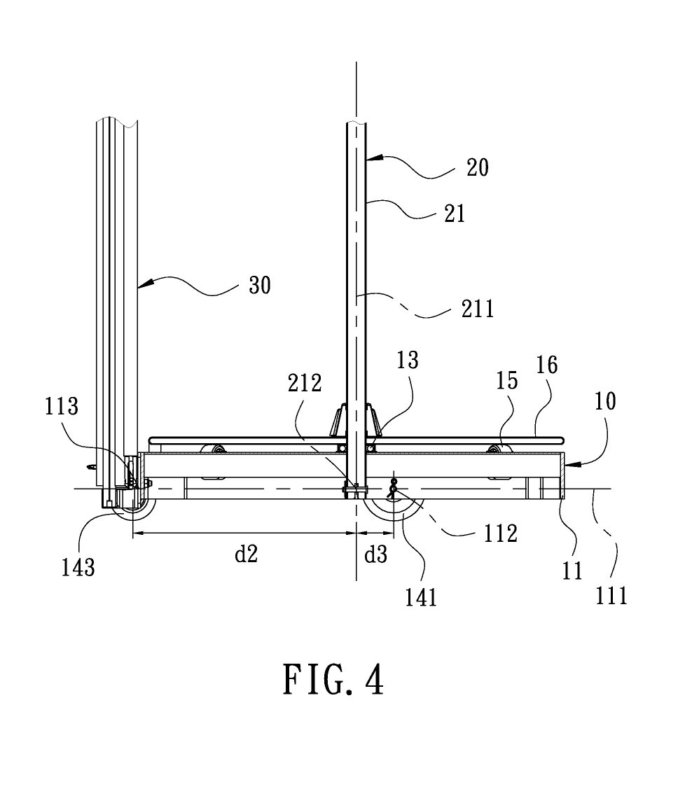

The movable base 10, particularly referring to FIG. 3 with reference to FIG. 4, comprises a positioning frame 11 in a polygonal shape, a plurality of flat wings 12 extending outwardly from the positioning frame 11, and a bearing 13 being located on the center portion of the positioning frame 11 for receiving the load unit 20. The positioning frame 11 is formed with a first axis 111 and a second axis 112 perpendicular to the first axis 111. The end portion 113 approximate to the axis 111 of the positioning frame forms the flat wings 12.

Further, a first castor set 14 is installed under the positioning frame 11 to bear the weight of the cutter structure. In this embodiment of a cutter for wrapping material according to the present invention, the first castor set 14 comprises a plurality of one-direction castors 141 positioned at a position at the two extreme of the second axis 112 and a plurality of steerable castors 142 positioned under the flat wings 12. Each of the steerable castors 142 is provided with a brake 143. Positioned on the top of the positioning frame 11, there is a second castor set 15 which comprises a plurality of castors 151 spaced apart appropriately around the circumference of the positioning frame 11, rotatable in a direction parallel to the edge of the positioning frame 11.

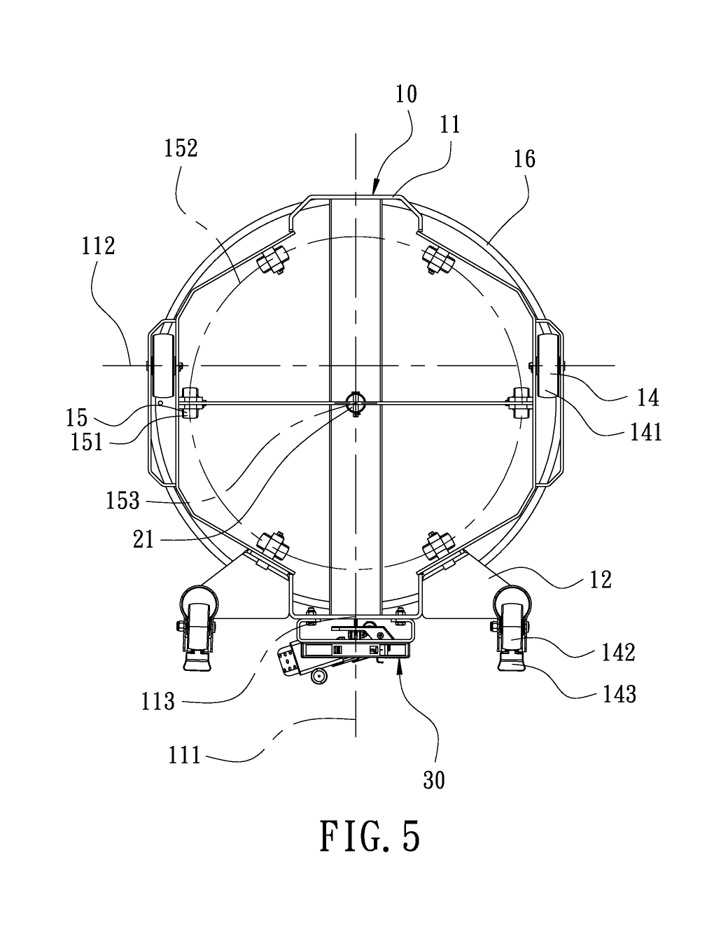

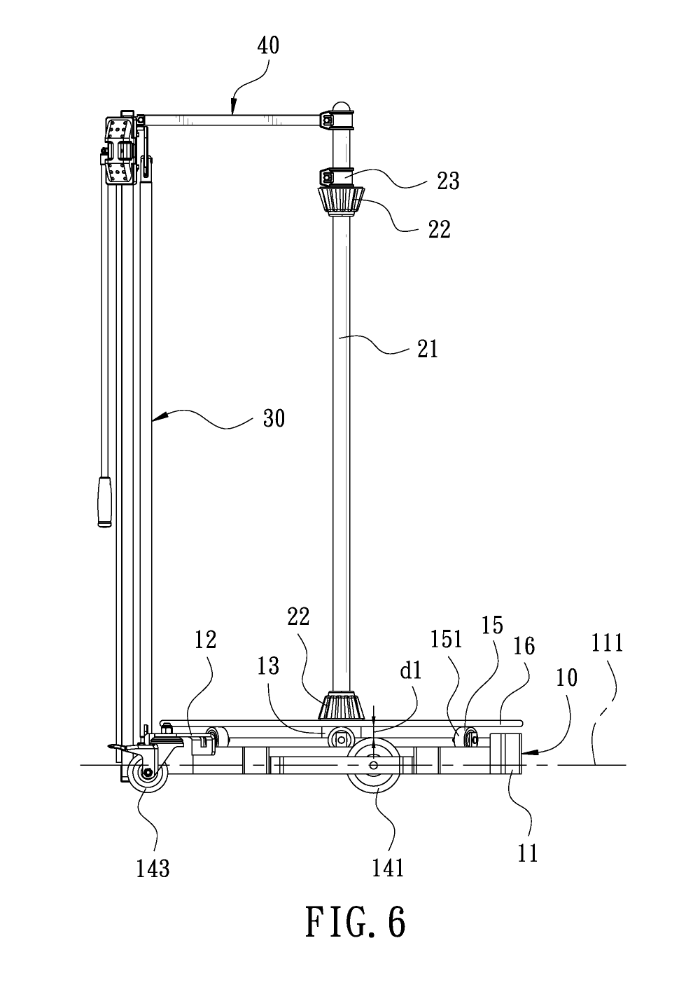

Referring to FIG. 3 with reference to FIG. 5, the rotation direction of the castors 151 is tangential to a hypothetical circle 152 which has a center 153. A turntable 16 is laid on the second castor set 15 which has a pivot hole 161 corresponding to the center of the bearing 13. With reference to FIG. 6, there is a gap distance d1 between the bottom surface of the turntable 16 and the circumference of the one-direction castor 141.

Still referring to FIG. 2 with reference to FIG. 4, a load unit 20 comprises a shaft 21 vertically fitted through the pivot hole 161, and at least a pair of fixing sleeve 22 and fastener 23 fixed on the shaft 21. In this embodiment, the shaft 21 is primarily inserted through the pivot hole 161 of the turntable 16 and also pivotally fitted into the bearing 13 on the center of the positioning frame 11. There are two fixing sleeves 22 and one fastener 23 to fix the shaft 21. Referring particularly to FIG. 4, the shaft 21 has an axle 211 intersecting with said first axis 111 at a cross point 212. The cross point 212 is between the second axis 112 and end portion 113 of the first axis 111 with a distance d2 as shown. There is a third distance d3 between the cross point 212 and the second axis 112. In the embodiment, the second distance d2 is larger than the third distance d3. The axle 211 does not cross with the second axis 112 but coincide with the center 153 of the circle 152.

Referring to FIGS. 2 and 3, a cutting unit 30 is provided within in a frame 31 vertically fixed at the end portion 113 on the positioning frame 11. A sliding rod 32 is provided in the frame 31 which is parallel to the shaft 21 to form a lengthy hole 33. And a blade base 34 is provided movably on the sliding rod 32 with a blade 35 formed thereon (referring to FIG. 5) beside the lengthy hole 33.

As shown in FIG. 6, a bolster rod 40 has two ends connected with the shaft 21 and the frame 31 respectively in a direction parallel with the first axis 111. In the present embodiment, the bolster rod 40 is connecting to the top of the shaft 21 and the frame 31 of the cutting unit 30.

A blade lever 50 comprises a connecting portion 51 pivotally connect with the blade base 34, and a grip 52 formed at another end.

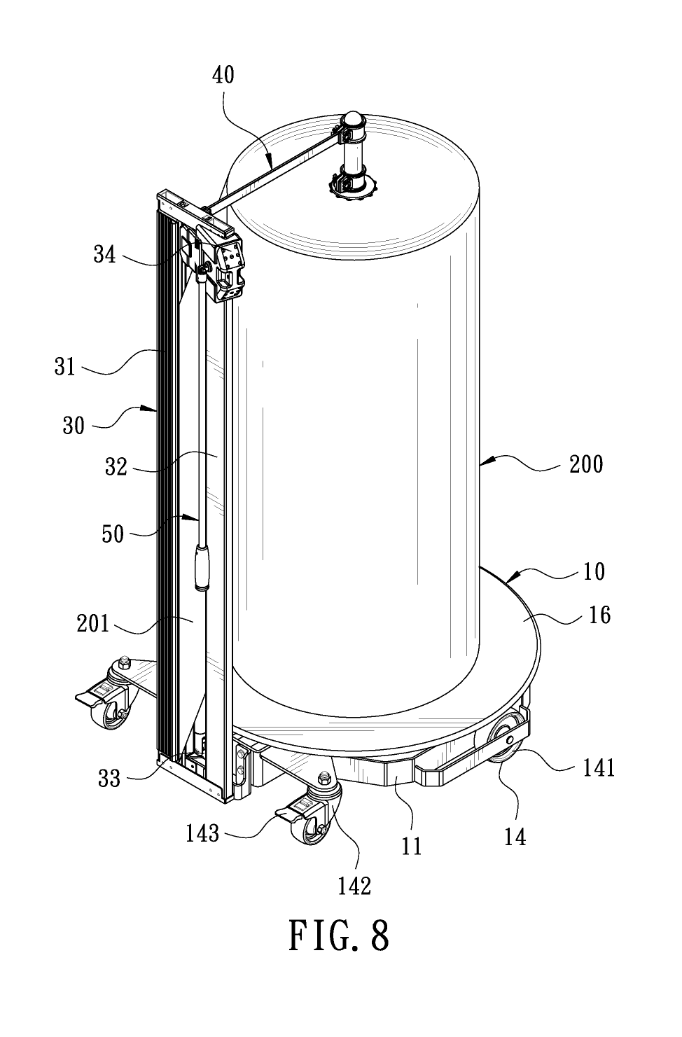

Referring to FIG. 8 which is a perspective view of the preferred embodiment of the cutter for wrapping material according to the present invention showing it is in operation. A packaging roll 200 has been inserted in the shaft 21 with the fixing sleeves 22 fitted in two ends of the packaging roll 200 respectively. The fastener 23 is tightened to restrain the fixing sleeve 22 from moving so that the packaging roll 200 can be stored steadily on the shaft 21. Then a part of packaging wrap 201 can be pulled out from the packaging roll 200 to pass through the lengthy hole 33 of the frame 31. Finally, with the blade lever 50 pulled to enable the blade base 34 to move along the sliding rod 32 so that the packaging wrap 201 can be cut off from the packaging roll 200.

If the cutter for wrapping material according to the present invention 100 is to be moved to another work space, user just needs to release the brakes 143 from the steerable castors 142 so that the positioning frame 11 can be easily moved with the assistance of the castors 141 and 142. And the brakes 143 can be pressed to lock the steerable castors 142 again after the cutter 100 has been moved to a new location.

Therefore the present cutter 100 can not only quickly cut off a piece of flat packaging wrap 201 from the packaging roll 200, but also be easily moved to another spot as the first roller set 14 is installed with the positioning frame 11.

It should be noted that with the load unit 20 and the cutting unit 30 vertically installed on the movable base 10, the entire size of the cutter for wrapping material according to the present invention can be reduced to a great extent.

Moreover, with the turntable 16 deposited on the second castor set 15, the weight of the packaging roll 200 loaded on the shaft 21 can be uniformly distributed on the turntable 16. Because the axle 211 of the load unit 20 intersects with first axis 111 at cross point 212 which is between the end portion 113 of the first axis 111 and the second axis 112, the gravity of the load unit shall fall on a point between the end portion 113 of the first axis 111 and the second axis 112. Also because the gravity of the cutting unit 30 is fallen on the end portion 113 of the first axis 111, the overall weight of the packaging roll 200 shall be by the load unit 20 and the cutting unit 30 resulted a stability of the overall cutter for the wrapping material.

Since the distance d2 is greater than the distance d3, the overall gravity of the load unit 20 and cutting unit 30 will fall toward the one direction castor 141. The load on the steerable castors 142 will be minimized. The rotation in direction of the cutter for the wrapping material according to the present invention shall be relatively easy by using the cutting unit 30 as axle for a rotation.

Because the rotation direction of the castors 151 is tangential to the circle 152 and the axle 211 of the shaft 21 coincides with the center 153 of the circle 152, when the packaging wrap 201 is pulled out from the packaging roll 200, the turntable 16 can rotate smoothly. Also, because there is a gap distance d1 between the bottom surface of the turntable 16 and the outer peripheral of the one direction castor 141, the rotation of the turntable 16 shall be more smoothly.

With the bolster rod 40 connected between the top of the shaft 21 and the frame 31, it can further improve the steadiness of the rotation of the shaft 21.

With the blade lever 50 combined with the blade base 34, a user can smoothly drive the blade base 34 along the sliding rod 32 up and down while standing and the operation of the cutter for wrapping material becomes more convenient. With the steerable castors 142 positioned under the flat wings 12 and protruded outside the turntable 16, a user can conveniently operate the brakes 143.

While the preferred embodiment of the invention has been described above, it will be recognized and understood that various modifications may be made therein and the appended claims are intended to cover all such modifications that may fall within the spirit and scope of the invention.

What is claimed is:

1. A vertical cutter for wrapping material comprising:
a movable base comprises a positioning frame which being in a shape with a first axis and a second axis perpendicular to said first axis, a plurality of flat wings formed at one end portion of said first axis of said positioning frame, a first castor set having a plurality of one direction castors and a plurality of steerable castors formed on said flat wings of said positioning frame, a second castor set having a plurality of castors on a circumference of said positioning frame, a bearing being provided at the center of said positioning frame, and a turntable having a pivot hole positioned on top of said castors of said second castor set;
a load unit comprises a shaft vertically passing through said pivot hole of said turntable and fixed on said bearing of said positioning frame, at least a fixing sleeve and a fastener fitted on said shaft; and
a cutting unit comprises a frame vertically fixed on said positioning frame, a sliding rod installed in said frame being parallel with said shaft of said load unit forming into a lengthy hole near said sliding rod, a blade base movably mounted on said sliding rod, a blade fixed on said blade base and positioning in said lengthy hole.

2. A vertical cutter for wrapping material as claimed in claim 1 wherein said shaft of said load unit having an axle which intersects with said first axis of said positioning frame at a cross point which being between said first axis and said second axis of said positioning frame.

3. A vertical cutter for wrapping material as claimed in claim 1 wherein said turntable of said positioning frame comprises a bottom surface, an outer peripheral of said one direction castors being distanced with said bottom surface of said turntable in a first distance.

4. A vertical cutter for wrapping material as claimed in claim 2 wherein said cross point and said end portion of said first axis having a second distance, said cross point and said second axis having a third distance, said second distance being greater than said third distance.

5. A vertical cutter for wrapping material as claimed in claim 1 further comprising a bolster rod positioned in parallel to said first axis of said positioning frame, and having two ends respectively connected with said shaft of said load unit and said frame of said cutting unit.

6. A vertical cutter for wrapping material as claimed in claim 1 wherein said cutting unit further comprises a blade lever having one end thereof pivotally connected with said blade base of cutting unit and another end thereof formed into a grip.
